(19) United States
(12) Patent Application Publication
(10) Pub. No.: US 2026/0213562 A1
(43) Pub. Date: Jul. 23, 2026

(54) BATTERY PROTECTION DEVICE AND CURRENT REGULATION SYSTEM FOR BATTERY POWER SUPPLY

(71) Applicant: Shandong Huizhou Technology Innovation Co., Ltd., Weifang (CN)

(72) Inventor: Chong YU, Changyi (CN)

(73) Assignee: Shandong Huizhou Technology Innovation Co., Ltd., Weifang (CN)

(21) Appl. No.: 19/032,382

(22) Filed: Jan. 20, 2025

(51) Int. Cl. H02J 7/94; H01M 10/42; H01M 10/48; H02J 7/00; H02J 7/63; H02J 7/70

(52) U.S. Cl. CPC H02J 7/94; H01M 10/425; H01M 10/488; H02J 7/63; H02J 7/70; H02J 7/855

(57) ABSTRACT

The invention is a battery protection device and a current regulation system for battery power supply. It features adjustable low- and high-voltage protection. It includes a housing, circuit board, first display screen, first and second buttons, indicator light, and sealing film. The first display screen, first button, second button, and indicator light are electrically connected to the circuit board. The first and second buttons set the minimum voltage output value. The first display screen displays the set minimum voltage output value and the real-time voltage of the battery. The indicator light indicates the device's on/off state. The circuit board is inside the housing. The housing’s upper surface has multiple openings. The first button, second button, indicator light, and first display screen protrude from the housing through corresponding openings. The sealing film covers the upper surface of the housing. The device offers high safety, long life, and good waterproofing.

### TECHNICAL FIELD

The present invention belongs to the technical field of battery protection and particularly relates to A Battery Protection Device and Current Regulation System for Battery Power Supply.

### BACKGROUND

A battery low-voltage protection device is used to protect batteries from over-discharge and low voltage. When the battery voltage falls below a set minimum voltage output threshold, the low-voltage protection device automatically triggers and cuts off the circuit, preventing further battery discharge and protecting the battery from damage. This protection mechanism is crucial for prolonging battery life and improving equipment reliability.

Currently, existing battery low-voltage protection devices are merely circuit boards without external protective structures, which is not conducive to waterproof protection. Moreover, since the buttons are directly set on the circuit board, operators' hands directly contact the circuit board and electronic components when setting the minimum voltage output value, affecting the circuit board's lifespan with long-term use.

### SUMMARY

In view of the above problems, the present invention discloses a battery protection device and a current regulation system for battery power supply to overcome or at least partially solve these issues.

To achieve this purpose, the present invention adopts the following technical solutions:

On one aspect, the present invention discloses a battery protection device with adjustable low-voltage protection and high-voltage protection functions, comprising a housing, a circuit board, a first display screen, a first button, a second button, an indicator light, and a sealing film.

The first display screen, first button, second button, and indicator light are electrically connected to the circuit board. The first and second buttons are used to set the minimum voltage output value of the battery protection device. The first display screen displays the set minimum voltage output value and the real-time voltage of the battery. The indicator light indicates the on/off state of the battery protection device. The circuit board is located inside the housing, and the upper surface of the housing has multiple openings. The first button, second button, indicator light, and first display screen protrude from the housing through corresponding openings, and the sealing film covers the upper surface of the housing.

Further, the sealing film is bonded to the housing with waterproof adhesive.

Further, the device includes an input line and an output line.

The input line and output line pass through wire holes on the side of the housing into the housing and are connected to the first and second terminal blocks on the circuit board, respectively. Waterproof wire plugs are provided in the wire holes for waterproof sealing between the input line, output line, and the housing.

Further, the housing comprises an upper shell and a lower shell.

A sealing groove is formed on the edge of the upper shell or the lower shell, and a sealing groove is provided in the sealing groove. The upper shell and lower shell are fixedly connected by screws or bolts.

Further, a "+" symbol is formed on the housing or sealing film at the first button, and a "-" symbol is formed on the housing or sealing film at the second button.

Further, the device includes a wireless remote control.

The wireless remote control has a control button and a second display screen. The wireless remote control can wirelessly connect with the radio frequency module on the circuit board. The control button is used to set the minimum voltage output value of the battery protection device, and the second display screen displays the set minimum voltage output value.

Further, the side of the housing extends to form a fixing part with mounting holes.

On another aspect, the present invention discloses a current regulation system for battery power supply, comprising a battery power supply device, a current regulator, and the aforementioned battery protection device.

The input end of the battery power supply device is connected to the battery. The output end of the battery power supply device is connected to the input end of the current regulator through the battery protection device. The output end of the current regulator is connected to the load. The battery power supply device is used to obtain electrical energy from the battery. The battery protection device provides low-voltage and high-voltage protection for the battery. The current regulator adjusts the current size of the load.

Further, the system includes a voltage display screen.

The voltage display screen is connected to the input end of the current regulator to display the output voltage of the battery; alternatively, the voltage display screen is connected to the output end of the current regulator to display the working voltage of the load.

The advantages and beneficial effects of the present invention are as follows:

In the battery protection device of the present invention, by setting a housing on the outside of the circuit board, the circuit board can be protected, preventing operators' hands from touching the electronic components on the circuit board during operation, which is not only safe but also prolongs the service life of the circuit board. Moreover, by setting a sealing film on the upper surface of the housing to cover the display screen and buttons, sealing is achieved between the display screen, buttons, and the housing, improving the waterproof performance of the battery protection device.

### BRIEF DESCRIPTION OF DRAWINGS

Through reading the detailed description of the preferred embodiments below, various other advantages and benefits will become clear to those skilled in the art. The drawings are only intended to show the purpose of the preferred embodiments and are not considered to be a limitation of the present invention. Moreover, the same reference symbols represent the same components throughout the drawings. In the drawings:

FIG. 1 is a three-dimensional structural diagram of a battery protection device in an embodiment of the present invention.

FIG. 2 is a top view of the battery protection device in an embodiment of the present invention.

FIG. 3 is a three-dimensional structural diagram of the battery protection device with the sealing film removed in an embodiment of the present invention.

FIG. 4 is a three-dimensional structural diagram of the circuit board in an embodiment of the present invention.

FIG. 5 is a top view of the circuit board in an embodiment of the present invention.

FIG. 6 is a top view of the upper shell in an embodiment of the present invention.

FIG. 7 is a bottom view of the upper shell in an embodiment of the present invention.

In the figures: 1. Housing; 1-1. Upper shell; 1-2. Lower shell; 2. Circuit board; 3. First display screen; 4. First button; 5. Second button; 6. Sealing film; 7. Opening; 8. Input line; 9. Output line; 10. First terminal block; 11. Second terminal block; 12. Waterproof wire plug; 13. Indicator light; 14. Sealing groove; 15. Fixing part; 16. Mounting hole.

### DETAILED DESCRIPTION OF THE EMBODIMENTS

In order to make the purpose, technical solutions, and advantages of the present invention clearer, the following will combine specific embodiments of the present invention and corresponding drawings to provide a clear and complete description of the technical solutions of the present invention. Obviously, the described embodiments are only a part of the embodiments of the present invention, not all of the embodiments. Based on the embodiments in the present invention, all other embodiments obtained by those skilled in the art without creative labor shall fall within the protection scope of the present invention.

The following describes the technical solutions provided by each embodiment of the present invention in detail with reference to the drawings.

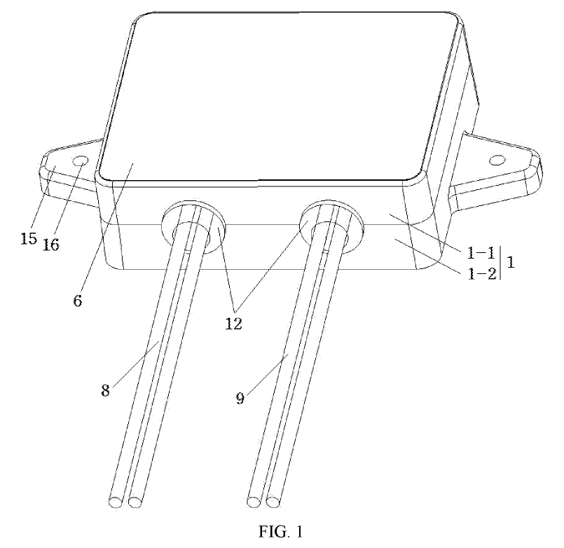

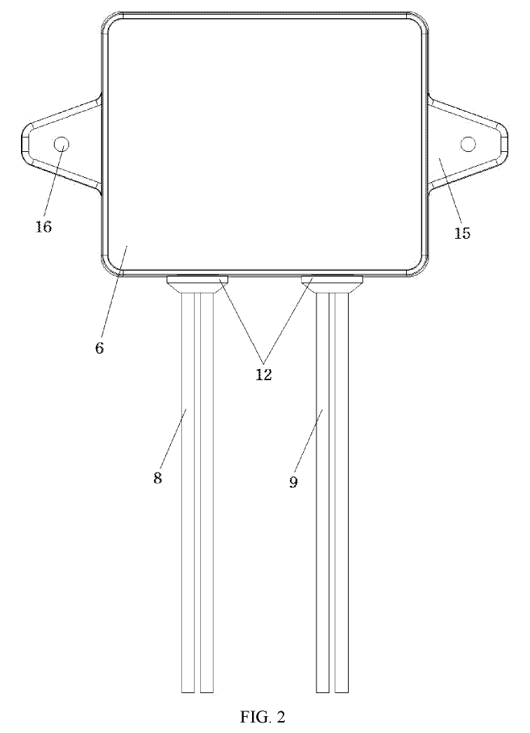

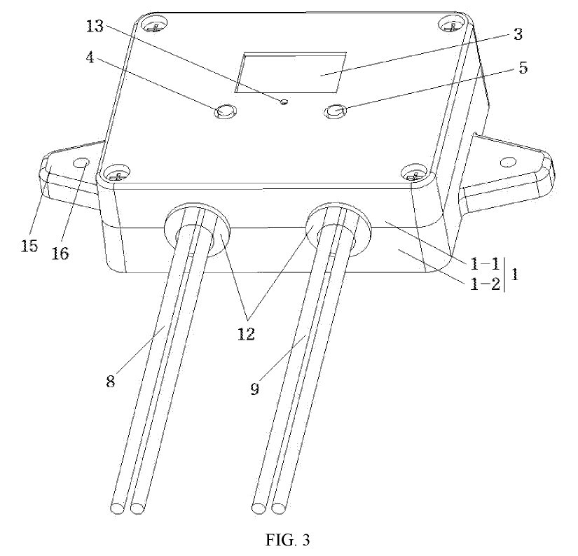

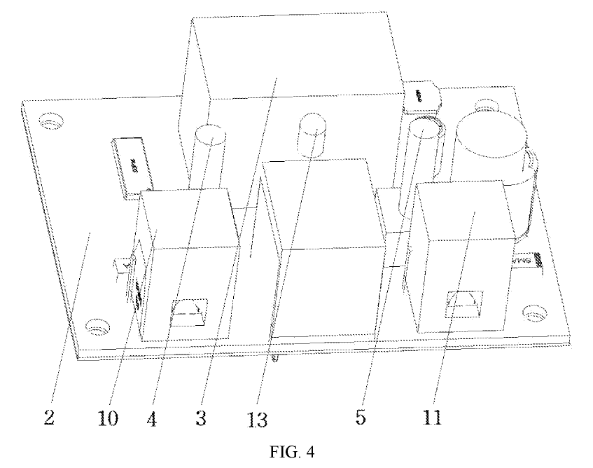

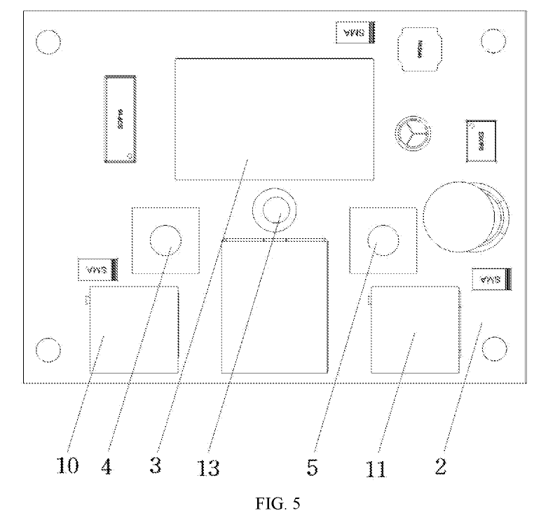

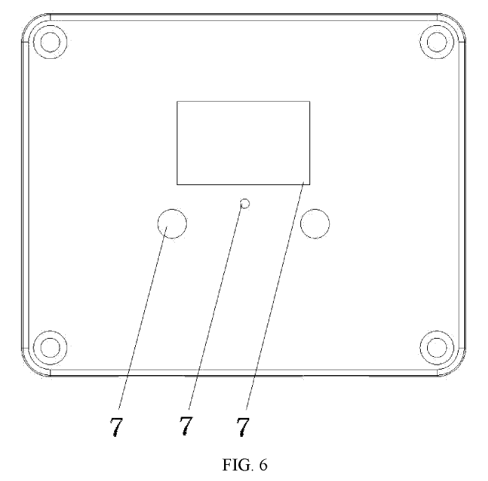

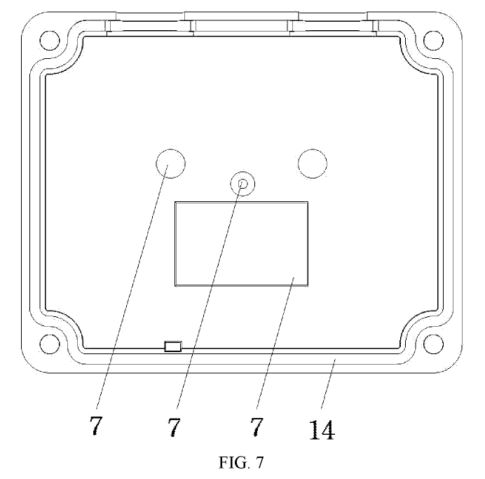

In an embodiment of the present invention, a battery protection device is provided. The battery protection device has adjustable low-voltage protection and high-voltage protection functions. When the battery voltage is too low, too high, or the instantaneous current is too large, the device will automatically cut off power, providing low-voltage and high-voltage protection for the battery, thereby extending the battery's service life. As shown in FIGS. 1 to 7, the battery protection device includes a housing 1, a circuit board 2, a first display screen 3, a first button 4, a second button 5, an indicator light 13, and a sealing film 6. Among them, the first display screen can be an LED display screen, and the housing can be made of plastic.

Specifically, the first display screen 3, first button 4, second button 5, and indicator light 13 are electrically connected to the circuit board 2. The first button 4 and the second button 5 are used to set the minimum voltage output value of the battery protection device. The first display screen 3 displays the set minimum voltage output value and the real-time voltage of the battery. The indicator light 13 indicates the on/off state of the battery protection device. Thus, operators can determine the on/off state of the battery protection device based on whether the indicator light 13 is on or off. When the battery protection device is off, the indicator light 13 is off; when the battery protection device is on, the indicator light 13 is on. A cavity is formed inside the housing 1, and the circuit board 2 is located in the cavity. The upper surface of the housing 1 has multiple openings 7, and the first button 4, second button 5, indicator light 13, and first display screen 3 protrude from the housing 1 through corresponding openings 7. Among them, the first button 4 and second button 5 both protrude from the upper surface of the housing 1 for easy pressing operation. The plane where the first display screen 3 is located is flush with the upper surface of the housing 1, making the battery protection device more aesthetically pleasing.

Moreover, the sealing film 6 covers the upper surface of the housing 1 and can simultaneously cover the first display screen 3, first button 4, and second button 5, sealing the gaps between the first display screen 3, first button 4, second button 5, and the housing 1. As a result, when operating the buttons, sweat from the hands will not enter the housing 1 through the above-mentioned gaps, giving the battery protection device excellent waterproof performance. Preferably, the sealing film 6 covers the entire upper surface of the housing 1. It should be noted that the sealing film needs to have a certain degree of light transmittance. Therefore, operators can clearly view the content displayed on the first display screen through the sealing film. For example, the sealing film can be a plastic film.

In addition, the first display screen 3 is located in the middle of the upper surface of the housing 1, and the first button 4 and second button 5 are located on both sides below the first display screen 3. This not only makes the battery protection device more aesthetically pleasing but also more convenient to operate.

In summary, in the battery protection device of this embodiment, by setting a housing on the outside of the circuit board, the circuit board can be protected. When operators operate the battery protection device, their hands will not touch the electronic components on the circuit board, which is not only safe but also prolongs the service life of the circuit board. Moreover, by setting a sealing film on the upper surface of the housing to cover the display screen and buttons, sealing is achieved between the display screen, buttons, and the housing, improving the waterproof performance of the battery protection device. The battery protection device can be applied to various DC power scenarios. The scenarios include children's car circuit modification, car batteries, power tool batteries, DC fans, DC decorative lights, solar energy storage, etc. The battery protection device sets and protects the minimum voltage value of the batteries in these application scenarios, avoiding excessive battery discharge.

In this embodiment, the sealing film is adhered to the shell with waterproof glue. This not only enhances the firm connection between the sealing film and the shell but also further improves the waterproof performance of the battery protector.

As shown in FIGS. 1 to 3, the battery protector also includes an input line 8 and an output line 9. Specifically, the input line 8 and the output line 9 pass through the wire holes on the side of the shell 1 and connect to the first terminal 10 and the second terminal 11 on the circuit board 2, respectively. During the wiring process, the input line 8 and the output line 9 only need to be connected to the battery and the load, respectively. Such process requires additional wires or connecting wires to the circuit board 2, making the wiring operation simpler.

Additionally, waterproof wire plugs 12 are installed in the wire holes to provide waterproof sealing between the input line 8, the output line 9, and the shell 1, preventing water from entering the shell 1 through the wire holes. In this embodiment, there are two wire holes, and the input line 8 and the output line 9 pass through the two wire holes into the shell 1. Both wire holes are equipped with waterproof wire plugs 12. This means that there are two waterproof wire plugs 12. Of course, in other embodiments, there can be only one wire hole, and both the input line 8 and the output line 9 pass through the same wire hole into the shell 1. In this case, only one waterproof wire plug 12 needs to be installed.

In this embodiment, as shown in FIGS. 1 to 3, 6, and 7, the shell 1 includes an upper shell 1-1 and a lower shell 1-2. The edge of the upper shell 1-1 forms a sealing groove 14, which contains a sealing groove, further improving the sealing performance between the upper shell 1-1 and the lower shell 1-2. The upper shell 1-1 and the lower shell 1-2 are fixed and connected by screws or bolts, making disassembly and assembly more convenient. The circuit board 2 is also fixed on the lower shell 1-2 with screws or bolts, ensuring the circuit board 2 is secured relative to the shell 1 and preventing the circuit board 2 from shaking inside the shell 1. Of course, the sealing groove 14 can also be set on the edge of the lower shell 1-2, which is also within the scope of protection of this invention.

Furthermore, as shown in FIGS. 1 to 3, the side of the shell 1 extends with fixing parts 15. There can be two fixing parts 15, symmetrically arranged on both sides of the shell 1. The fixing parts 15 have mounting holes 16. This allows the battery protector to be fixed on other structures through the mounting holes 16, making installation more convenient.

In addition, the shell or the sealing film at the first button is marked with a "+" symbol, and the shell or the sealing film at the second button is marked with a "-" symbol. This way, the operator can determine the functions of the first button and the second button based on the symbols to achieve precise control of the battery protector.

In a specific embodiment, the input voltage of the battery protector is 12 V ~ 40 V, the output voltage is 12 V ~ 40 V, the limit working current is 20 A, and the operating temperature is -20℃ ~ 40℃. The battery power supply is connected to the input port (input line), and the minimum pass-through voltage (to prevent battery under-voltage) is set through the first button and the second button. The operation method is as follows:

Setting Example 1: When the output voltage of the battery power supply is lower than 12.5 V, the battery protector stops (disconnects); when the output voltage of the battery power supply is higher than 14 V, the battery protector starts (conducts).

Setting the protection value: Press the "+" (first button) once, and the protection value is displayed on the first display. Long press the "+" (first button), and the decimal point of the protection value flashes, indicating that the battery protector has entered the setting mode. At this time, use the "+" (first button) and "-" (second button) to change the value of the protection value to 12.5. After 3 seconds of no operation, the battery protector will automatically save and exit the setting mode. Setting the hysteresis value: Press the "-" (second button) once, and the hysteresis value is displayed on the first display. Long press the "-" (second button), and the decimal point of the hysteresis value flashes, indicating that the battery protector has entered the setting mode. At this time, use the "+" (first button) and "-" (second button) to change the value of the hysteresis value to 1.5. After 3 seconds of no operation, the battery protector will automatically save and exit the setting mode, indicating that the setting is successful.

Setting Example 2: When the output voltage of the battery power supply is lower than 10 V, the battery protector stops (disconnects); when the output voltage of the battery power supply is higher than 15.5 V, the battery protector starts (conducts).

Setting the protection value: Press the "+" (first button) once, and the protection value is displayed on the first display. Long press the "+" (first button), and the decimal point of the protection value flashes, indicating that the battery protector has entered the setting mode. At this time, use the "+" (first button) and "-" (second button) to change the value of the protection value to 10. After 3 seconds of no operation, the battery protector will automatically save and exit the setting mode. Setting the hysteresis value: Press the "-" (second button) once, and the hysteresis value is displayed on the first display. Long press the "-" (second button), and the decimal point of the hysteresis value flashes, indicating that the battery protector has entered the setting mode. At this time, use the "+" (first button) and "-" (second button) to change the value of the hysteresis value to 5.5. After 3 seconds of no operation, the battery protector will automatically save and exit the setting mode, indicating that the setting is successful.

Restoring the battery protector to factory settings: With the battery power supply disconnected, press and hold both the "+" (first button) and "-" (second button), then connect the battery power supply. At this time, the first display shows "888", indicating that the factory settings have been successfully restored. The factory default voltage protection value is 12 V, and the hysteresis value is 2V.

It should be noted that the hysteresis value can be understood as an error value. When the output voltage of the battery power supply reaches the set stop value, it will be unstable and fluctuate around the set stop value, causing the relay to repeatedly attract and jump. Therefore, setting a hysteresis value allows the battery protector to recognize an error range to ensure stable operation of the battery protector.

In other embodiments, the battery protector also includes a wireless remote control (not shown in the figure).

In this embodiment, the wireless remote control is equipped with control buttons and a second display screen. The wireless remote control can wirelessly connect to the radio frequency module on the circuit board. The control buttons are used to set the minimum voltage output value of the battery protector, and the second display screen is used to display the set minimum voltage output value. This way, the wireless remote control enables wireless control of the battery protector. This allows the operator to set the minimum voltage output value of the battery protector without touching it, thereby making the control of the battery protector more convenient.

Another embodiment of this invention provides a current regulation system for battery power extraction. Such system includes a battery power extractor, a current regulator, and the battery protector described in the previous embodiments.

Specifically, the input end of the battery power extractor is connected to the battery, and the output end of the battery power extractor is connected to the input end of the current regulator through the battery protector. The output end of the current regulator is connected to the load. The battery power extractor is used to obtain electrical energy from the battery, the battery protector is used to provide low-voltage protection and high-voltage protection for the battery, and the current regulator is used to adjust the current size of the load as needed.

This current regulation system for battery power extraction can not only adjust the current size of the load but also provide low-voltage protection and high-voltage protection for the battery. It is mainly applied in scenarios such as speed regulation of modified children's cars, adjustment of light brightness, regulation of fan speed, and regulation of water pumps.

Furthermore, the current regulation system for battery power extraction also includes a voltage display screen.

The voltage display screen is connected to the input end of the current regulator to display the output voltage of the battery, or the voltage display screen is connected to the output end of the current regulator to display the working voltage of the load. This way, the status of the battery or load can be understood through the voltage display screen, making it more convenient to use.

The above description is only a specific embodiment of this invention. Under the above teaching of this invention, those skilled in the art can make other improvements or modifications based on the above embodiments. Those skilled in the art should understand that the specific description above is only for better explaining the purpose of this invention, and the scope of protection of this invention should be based on the scope of protection of the claims.

What is claimed is:

1. A battery protection device with adjustable low-voltage protection and high-voltage protection functions, characterized by comprising a housing, a circuit board, a first display screen, a first button, a second button, an indicator light, and a sealing film;
The first display screen, first button, second button, and indicator light are electrically connected to the circuit board; the first and second buttons are used to set the minimum voltage output value of the battery protection device; the first display screen displays the set minimum voltage output value and the real-time voltage of the battery; the indicator light indicates the on/off state of the battery protection device; the circuit board is located inside the housing; the upper surface of the housing has multiple openings; the first button, second button, indicator light, and first display screen protrude from the housing through corresponding openings; and the sealing film covers the upper surface of the housing.

2. The battery protection device according to claim 1, characterized in that the sealing film is bonded to the housing with waterproof adhesive.

3. The battery protection device according to claim 1, further comprising an input line and an output line;
The input line and output line pass through wire holes on the side of the housing into the housing and are connected to the first and second terminal blocks on the circuit board, respectively; waterproof wire plugs are provided in the wire holes for waterproof sealing between the input line, output line, and the housing.

4. The battery protection device according to claim 1, characterized in that the housing comprises an upper shell and a lower shell;
A sealing groove is formed on the edge of the upper shell or the lower shell, and a sealing groove is provided in the sealing groove; the upper shell and lower shell are fixedly connected by screws or bolts.

5. The battery protection device according to claim 1, characterized in that a "+" symbol is formed on the housing or sealing film at the first button, and a "-" symbol is formed on the housing or sealing film at the second button.

6. The battery protection device according to claim 1, further comprising a wireless remote control;
The wireless remote control has a control button and a second display screen; the wireless remote control can wirelessly connect with the radio frequency module on the circuit board; the control button is used to set the minimum voltage output value of the battery protection device, and the second display screen displays the set minimum voltage output value.

7. The battery protection device according to claim 1, characterized in that the side of the housing extends to form a fixing part with mounting holes.

8. A current regulation system for battery power supply, characterized by comprising a battery power supply device, a current regulator, and the battery protection device according to claim 1;
The input end of the battery power supply device is connected to the battery; the output end of the battery power supply device is connected to the input end of the current regulator through the battery protection device; the output end of the current regulator is connected to the load; the battery power supply device is used to obtain electrical energy from the battery; the battery protection device provides low-voltage and high-voltage protection for the battery; and the current regulator adjusts the current size of the load.

9. The current regulation system for battery power supply, according to claim 8, further comprising a voltage display screen;
The voltage display screen is connected to the input end of the current regulator to display the output voltage of the battery; alternatively, the voltage display screen is connected to the output end of the current regulator to display the working voltage of the load.
